(19) United States
(12) Patent Application Publication
(10) Pub. No.: US 2009/0122795 A1
(43) Pub. Date: May 14, 2009

(54) Method and apparatus for providing a shared message

(75) Inventors: Juha H-P Nurmi, Salo (FI); Jussi Koskela, Turku (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/985,578

(22) Filed: Nov. 14, 2007

(51) Int. Cl. H04L 12/56

(52) U.S. Cl. 370/389

(57) ABSTRACT

According to some embodiments of the present invention provides a new and unique technique to extend a point-to-point communication with a point-to-multipoint feature. Each end node has, beside a unique address, a configurable address that can be updated via some configuration means from a control entity. The unique address is a dedicated address. Different end node can have the same configurable address. The sender of a message or packet must be aware of the used addresses in the system. The technique does not require any changes to the normal data communication protocol. The messages or packets are unchanged. The implementation is done on the sender side and in the end node. Each message or frame or packet contains only one address. Each message and packet is received by each end node. A message is used by an end node if the unique or configurable address is matching. Beside that there is a possibility that the filtering is done by a hub that is selecting the right end node according the port definition (each output port has a dedicated unique address and configurable address). Moreover, the shared image frame has been sent once by the sender, which results in lower power consumption and less load on the sender.

### BACKGROUND

1. Field of Invention

The present invention relates to a communications technology, such as, for example, a hub, a wired data interface, e.g. a universal serial bus (USB), an inter-integrated circuit (I2C) or any other serial communication technology systems. More particularly, the present invention relates to sending the same information, e.g. a video clip, document, files, etc., to peripherals, nodes, points, terminals, or devices in a communication network or system, such as systems like a shared bus system or a hub system, especially in networks such as a wireless local area network (WLAN), a Universal Mobile Telecommunications System (UMTS) packet network architecture, Worldwide Interoperability for Microwave Access Forum (WiMAX), Ultra wide-band (UWB), or any other suitable communications technology like for example Bluetooth (BT).

2. Description of Related Art

There are many communication links available that are capable of point-to-point communication. Most of them are working in a unicast mode. There are use cases where there is a need to transmit the same data to many communication nodes. This could be reached by transmitting the same data multiple times or another possibility would be to transmit the data once but they should reach several communication nodes or peripherals at the same time. In that mode there is a need for an identification of that special data.

For example, in control line based peripheral selection the sender is selecting the target peripheral via a selection line (Chip Select=CS). Each peripheral needs its own CS line which is connected to the sender.

Alternatively, in package based peripheral selection the sender is sending packages where a package contains at least two fields. One field is used for the address and another field for the data. The sender is using the address field to select a peripheral where the data of the package should be sent. Each peripheral has its own unique address that is not the same with other peripherals. However, one problem on package based peripheral selection buses is that the sender has to send for example the same image information to each peripheral that is using the same bus (e.g. I2C) or the hub solution if the same image content (same resolution, etc.) is wanted to show, e.g., on the display module and television output.

### SUMMARY

The present invention provides a new and unique method and apparatus to extend a point-to-point communication (e.g. I2C, USB, or any other serial link) with a point-to-multipoint (like multicast) feature, wherein a command is provided to update a configurable address of a communication node in a communication system so as to be able to receive shared data; and the shared data and a destination address is provided so that one or more communication nodes process the shared data if either their respective unique address or configurable address matches the destination address.

The one or more communication nodes may be a peripheral, including a main display, or a television output, or a sub-display, or a high definition multimedia interface, or a mass storage, or any other functional module in a shared bus system, as well as hubs having ports in a hub system.

The shared data may include a message, a frame or a packet, or a package.

The method may include configuring different communications nodes to have the same configurable address to receive the shared data, as well as broadcasting a multicast signal having the shared data and destination address to all nodes in the communication system. The method may also include implementing the step of the method via a computer program running in a processor, controller or other suitable module in one or more nodes, points, terminals, devices or functional modules in the communication system.

In particular, according to some embodiments of the present invention extends the point-to-point communication with the point-to-multipoint feature, such that each end node has, beside a unique address that can be a hardware address or a hardwired address or a modifiable address that may be programmable during a system initialization process, further a software (SW) address that can be updated via some configuration means from a control entity during runtime. The SW address is named configurable address in the following. The configurable address is used for group identification. Different end nodes can have the same configurable address. The sender of a message or packet must be aware of the used unique address and configurable addresses in the system. Another possibility is that a control entity in the system is aware of all addresses and the originator of the message is requesting the related addresses from the control entity. The control entity is also responsible for configuration of the group addresses of the communication nodes.

The technique does not require any changes to the normal data communication protocol. The messages or packets or frames are unchanged. The implementation is done on the sender side and in the end node. Each message or frame or packet contains at least one destination address. Each message or frame or packet is received by each communication node or peripheral. A message is used by the communication node or peripheral if the unique address or configurable address is matching with the destination address in the message. Beside that there is a possibility that the filtering of messages or packets or frames may be done by a hub that is selecting the right end node according to the port definition. In that scenario each hub output port has a unique address and a configurable address. Moreover, the shared data may be sent once by the sender, which results in lower power consumption and less load on the sender and on the communication link.

In operation, each end node has, beside its unique address, a configurable address that can be updated via some configuration means from a control entity. Further there is no need for an indication in any message or frame or packet to indicate the multicast purpose of the message or frame or packet.

According to some embodiments of the present invention, the apparatus may take the form of a node, point, terminal, device or a functional module featuring one or more modules configured for providing the command to update the configurable address of one or more communication nodes in the communication system so as to be able to receive the shared data; and one or more modules configured for providing the shared data and the destination address so that one or more communication nodes process the shared data if either their respective unique address or configurable address matches the destination address.

The apparatus may also take the form of a system featuring one node, point, terminal or device having one or more modules configured for providing the command to update the configurable address of one or more communication nodes in the communication system so as to be able to receive shared data, and for also providing the shared data and a destination address; in combination with another node, point, terminal or device having one or more modules configured for receiving the command and updating the configurable address so as to be able to receive the shared data, and for also receiving the shared data and the destination address and processing the shared data if either its respective unique address or configurable address matches the destination address.

According to some embodiments the present invention may also take the form of a chipset featuring one or more such modules configured for providing the aforementioned functionality.

According to some embodiments the present invention may also take the form of a computer program product with a program code, which program code is stored on a machine readable medium, for carrying out the steps of the aforementioned method for providing such shared data, when the step of the method via a computer program running, e.g., in a processor, controller or other suitable module in one or more mobile nodes, points, terminals, devices or functional modules.

According to some embodiments the present invention may also take the form of a method for receiving shared data, featuring, e.g., steps of receiving in the communication node in the communication system the command to update the configurable address so as to be able to receive shared data; and receiving in the communication node the shared data and the destination address so that the communication node processes the shared data if either its respective unique address or configurable address matches the destination address.

According to some embodiments the present invention may also take the form of a receiving node, point, terminal, device, peripheral or functional module in such a communication system, featuring one or more modules configured for receiving in the communication node the command to update the configurable address so as to be able to receive shared data; and also for receiving in the communication node the shared data and the destination address so that the communication node processes the shared data if either its respective unique address or configurable address matches the destination address.

According to some embodiments the present invention may also take the form of a computer program product with a program code, which program code is stored on a machine readable medium, for carrying out the steps of the aforementioned method for receiving shared data, when the step of the method via a computer program running in a processor, controller or other suitable module in one or more nodes, points, terminals, devices or peripherals in the communication system.

According to some embodiments the present invention may also take the form of a method featuring updating the configurable address of the communication node so as to be able to receive shared data; and processing the shared data in the communication node if either its respective unique address or configurable address matches a destination address associated with the shared data.

The scope of the invention may also include implementing the same in a mobile node, point, terminal or device in that forms part of a wireless communications technology, including a wireless local area network (WLAN), WiMAX, UWB, or other suitable network, such as IEEE 802.XX technologies, including a mobile node, point, terminal or device having a two-part implementation. In this case, the mobile node, point, terminal or device may take the form of a station (STA), an access point (AP), or other suitable network node, point, terminal or device in the WLAN. Moreover, the scope of the invention may also include implementing the same in such a mobile node, point, terminal or device having such a two-part implementation using, e.g., a radio modem chipset in combination with a host processor chipset being configured for performing the functionality according to some embodiments of the present invention.

### BRIEF DESCRIPTION OF THE DRAWING

The drawing includes the following figures, which are not necessarily drawn to scale:

FIG. 1 shows a block diagram of a mobile node, point, terminal or device for providing a packet, package or message according to some embodiments of the present invention.

FIG. 2a shows a block diagram of the engine and software forming part of the mobile node, point, terminal or device shown in FIG. 1 according to some embodiments of the present invention.

FIG. 2b shows a flowchart of the basic steps of the method according to some embodiments of the present invention.

FIG. 2c shows an example of a package being sent to one or more peripherals according to some embodiments of the present invention.

FIG. 3a shows a block diagram of a receiving node, point, terminal or device for receiving a package or message according to some embodiments of the present invention.

FIG. 3b shows a flowchart of the basic steps for receiving the package or message by the receiving node, point, terminal or device shown in FIG. 3a according to some embodiments of the present invention.

FIG. 4, including FIGS. 4a to 4e, shows a diagram of a shared bus implementation according to some embodiments of the present invention.

FIG. 5, including FIGS. 5a and 5b, shows a diagram of a hub implementation according to some embodiments of the present invention.

FIG. 6 shows a chipset that forms part of the node, point, terminal or device shown in FIG. 1 according to some embodiments of the present invention.

FIG. 7 shows typical parts of an IEEE 802.11 WLAN system having the mobile node, point, terminal or device shown in FIG. 1 according to some embodiments of the present invention.

FIGS. 8a and 8b show diagrams of the Universal Mobile Telecommunications System (UMTS) packet network architecture having the mobile node, point, terminal or device shown in FIG. 1 according to some embodiments of the present invention.

### INVENTION

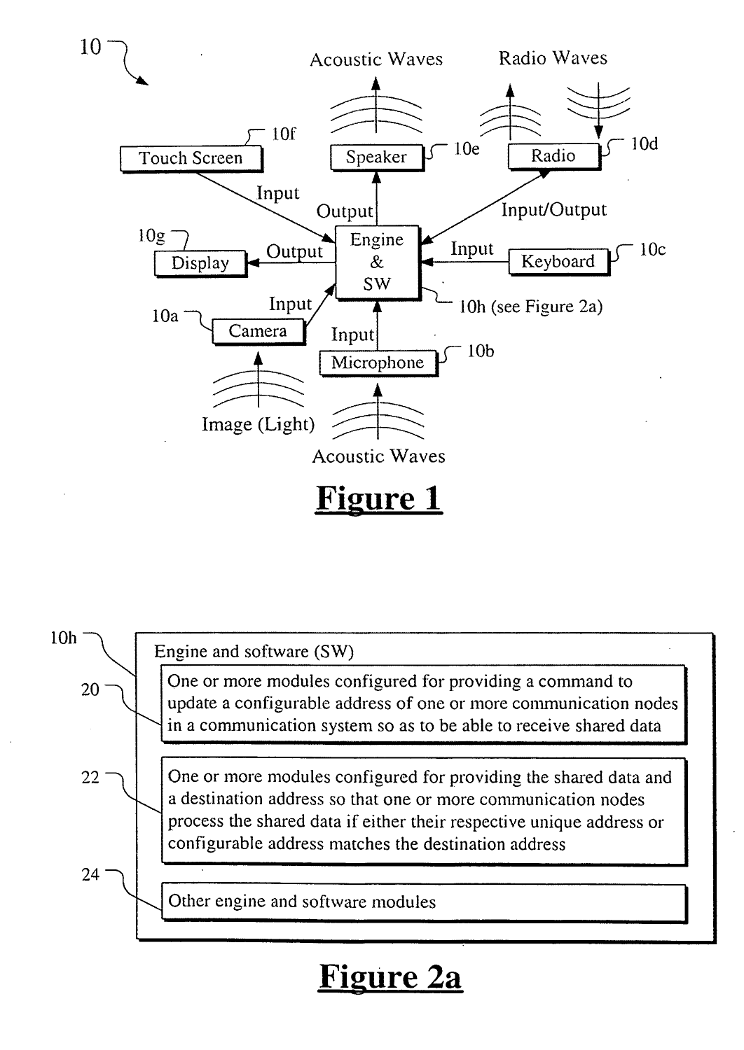

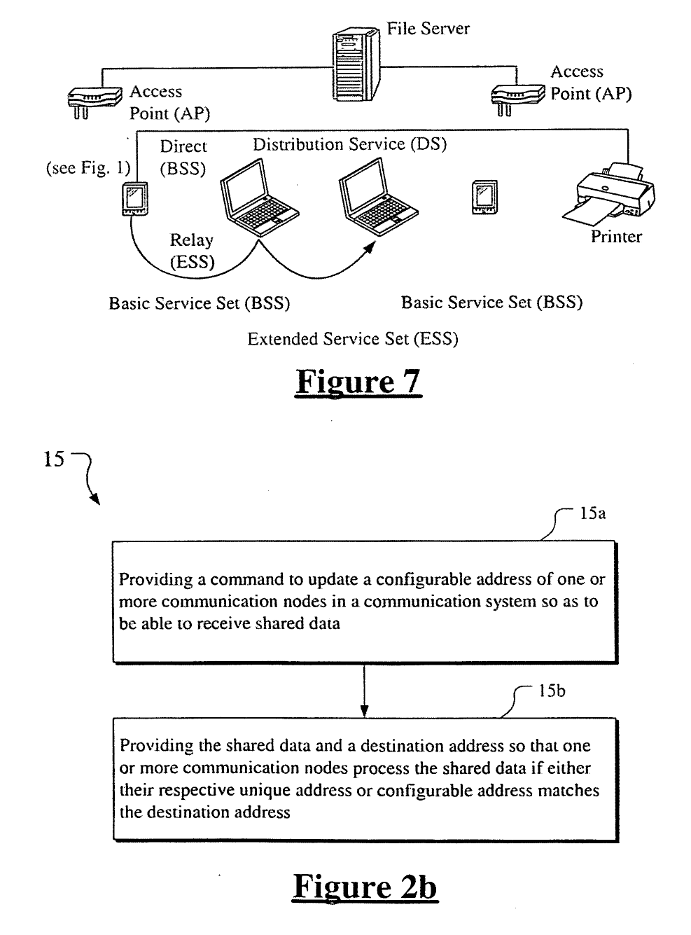

FIG. 1 shows a mobile node, point, terminal or device generally indicated as 10 according to some embodiments of the present invention. The mobile node, point, terminal or device 10 may include, e.g., numerous electrical or peripheral components or modules such as a camera 10a, a microphone 10b, a keyboard 10c, a radio 10d, a speaker 10e, a touch screen 10f, a display 10g, etc. The numerous electrical or peripheral components or modules are listed by way of example, and the scope of the invention is intended to include other electrical or peripheral components or modules either now known or later developed in the future including any functional modules that are used for executing particular functions in a system. In operation, the microphone is a component which is converting audio from acoustic waves to electrical format; the speaker is a component which is converting audio from electrical format to acoustic waves; the keyboard is a component which is converting information from pressed keys; the radio part is a component which is converting electrical information from/to radio waves; the display is a component which is converting electrical information to readable format; the touch screen is a component which is converting physical touches to electrical format. The camera part is a component which is converting image, which is based on different level of light from an object.

The numerous electrical or peripheral components also includes an engine and software (SW) module 10h which is controlling these conversions as well as an user interface of the display, which is on the mobile device. The engine or software 10 may be connected to the numerous electrical or peripheral components by many different types of interfaces, including a shared bus (e.g. I2C, etc.) or a hub system or any other serial interconnect mechanism, in order to provide frames, packets, packages or messages containing data or information to these numerous electrical or peripheral components. The numerous electrical or peripheral components 10a-10g all together form a communication system inside the mobile node, point, terminal or device 10, and the camera 10a, microphone 10b, keyboard 10c, radio 10d, speaker 10e, touch screen 10f and display 10g take the form of communication nodes or peripherals in relation to the engine or software module 10h, which controls and manages their operation, including sending packets, packages or messages. For example, the engine or software 10h may be responsible for sending video frames to two or more of such peripheral components. When two or more of such peripheral components receive the same information in such a manner, the information is known as shared data. Each of the numerous electrical or peripheral components has a unique address that can be hardwired, which is known by the engine or software 10h. When the engine or software 10h needs to send one or more frames, packets, packages or messages to such peripheral components, it may send the one or more frames, packets, packages or messages along on the communications system with a destination address corresponding to the electrical or peripheral component intended to receive the one or more frames, packets, packages or messages.

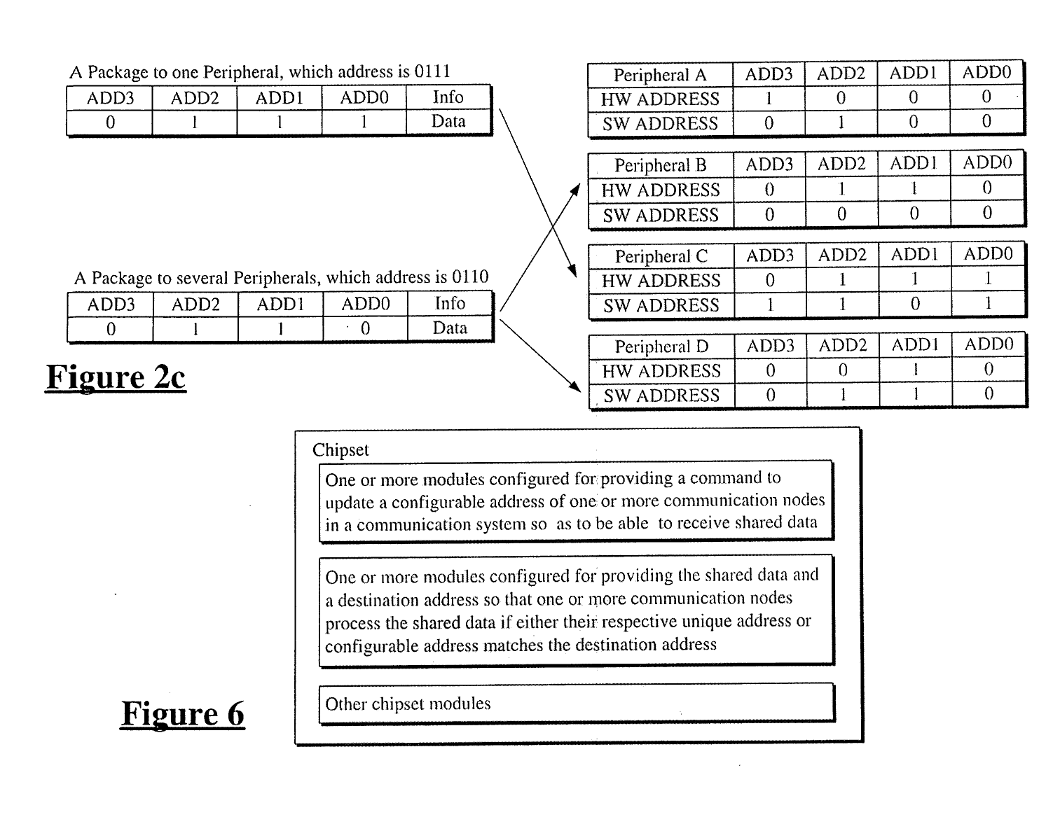

FIG. 2a shows the engine or software 10h is further detail, and includes one or more modules 20 and 22 that cooperate together to provide such frames, packets, packages or messages to the numerous electrical or peripheral components 10a-10g using a new and unique technique according to some embodiments of the present invention. In operation, the one or more modules 20 are configured for providing a command to update a configurable address of a communication node (e.g. peripheral) in the communication system so as to be able to receive shared data; and the one or more modules 22 are also configured for providing the shared data and the destination address so that one or more communication nodes process the shared data if either their respective unique address or configurable address matches the destination address.

The scope of the invention is not intended to be limited to performing the aforementioned functionality in one module or two, or using hardware or software consistent with that is described below. The engine and software 10h may include other modules 24 that are known in the art, do not form part of the underlying invention, and are not described herein.

FIG. 2b shows a flowchart 15 having basic steps 15a, 15b of the method of providing the shared data according to some embodiments of the present invention.

FIG. 2c shows an example of packages being sent to one or more peripherals A, B, C and D using a destination address of “0111” and “0110”. As shown, the upper package is sent to one peripheral C using an address of “0111”, while the lower package is sent to several peripherals B and D using an address of “0110”. As peripheral B has a logical unique (hardware) address of “0110” and peripheral D has a logical configurable (software) address of “0110” both peripherals are using the lower package.

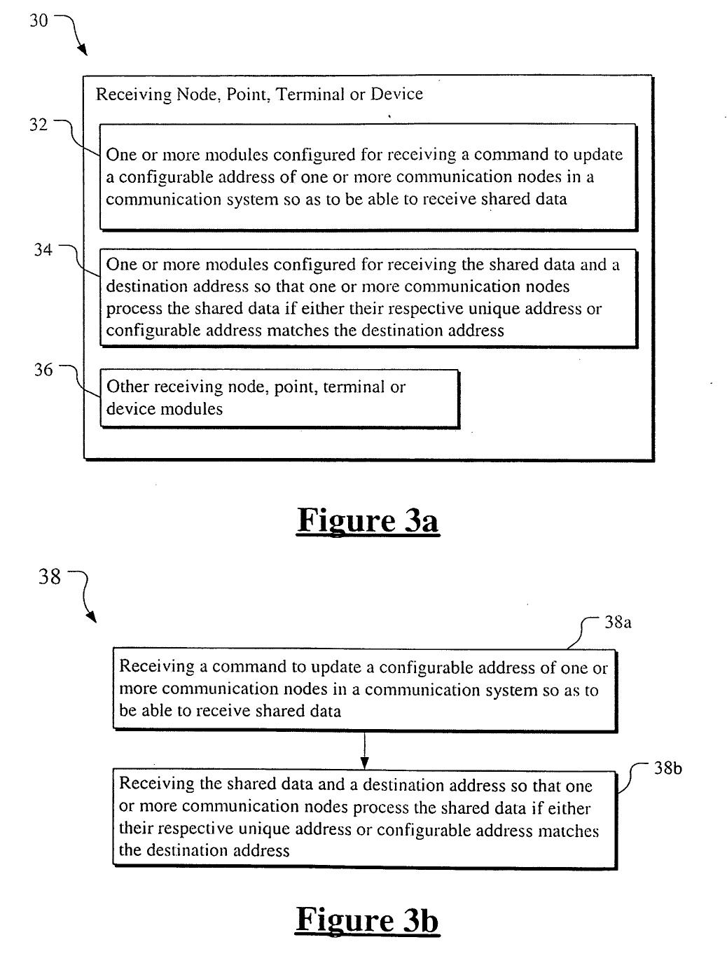

FIG. 3a shows a receiving node, point, terminal or device generally indicated as 30, which may take the form of any one or more of the numerous electrical or peripheral components 10a-10g (See FIG. 1), having modules 32, 34 and 36. In operation, the one or more modules 32 are configured for receiving in the communication node or peripheral the command to update the configurable address so as to be able to receive the shared data; and the one or more modules 34 are configured for receiving in the communication node or peripheral the shared data and the destination address and processing the shared data if either its respective unique address or configurable address matches the destination address.

The other modules 36 are known in the art, do not form part of the underlying invention, may include modules to perform the basic functionality of the respective peripheral and are not described herein.

FIG. 3b shows a flowchart 38 having basic steps 38a, 38b of the method of receiving the shared data according to some embodiments of the present invention.

In particular, the overall technique according to some embodiments of the present invention may be implemented, by way of example, as follows:

The engine and software 10h (FIG. 1) can send a shared image frame (or any other shared information e.g. a word document to mass memories (memory stick, hard disk, etc.)) once to all needed peripherals on the package based peripheral selection buses in either a shared bus or hub system configuration.

In the shared bus case (I2C, etc.), the peripherals may include two addresses—a unique address (HWAD), which is defined permanent (e.g. configuration pins, one time programmable (OTP), etc.), and a software address (SWAD), which can be changed by the engine via specific configuration commands. The engine can change the software address of the peripherals to what are needed to receive the shared image information from the engine at the same time. The unique and software addresses are typically the same in the normal case. That means when the engine wants to send information only to one peripheral at one time.

In comparison, in the hub case, the hub may include two output addresses for each output port—a unique output address (HWOADD, this is as same as the physical output port), which is defined permanently (e.g. configuration pins, OTP, etc.), and a configurable output address (SWOADD), which can be changed by the engine with a specific command. The engine can change the configurable output address (SWOAD) of the hub output port for a peripheral to what is needed to receive the shared image information from the engine at the same time. The unique address and the configurable addresses are typically the same in the normal case. That means when the engine wants to send information only to one peripheral at one time.

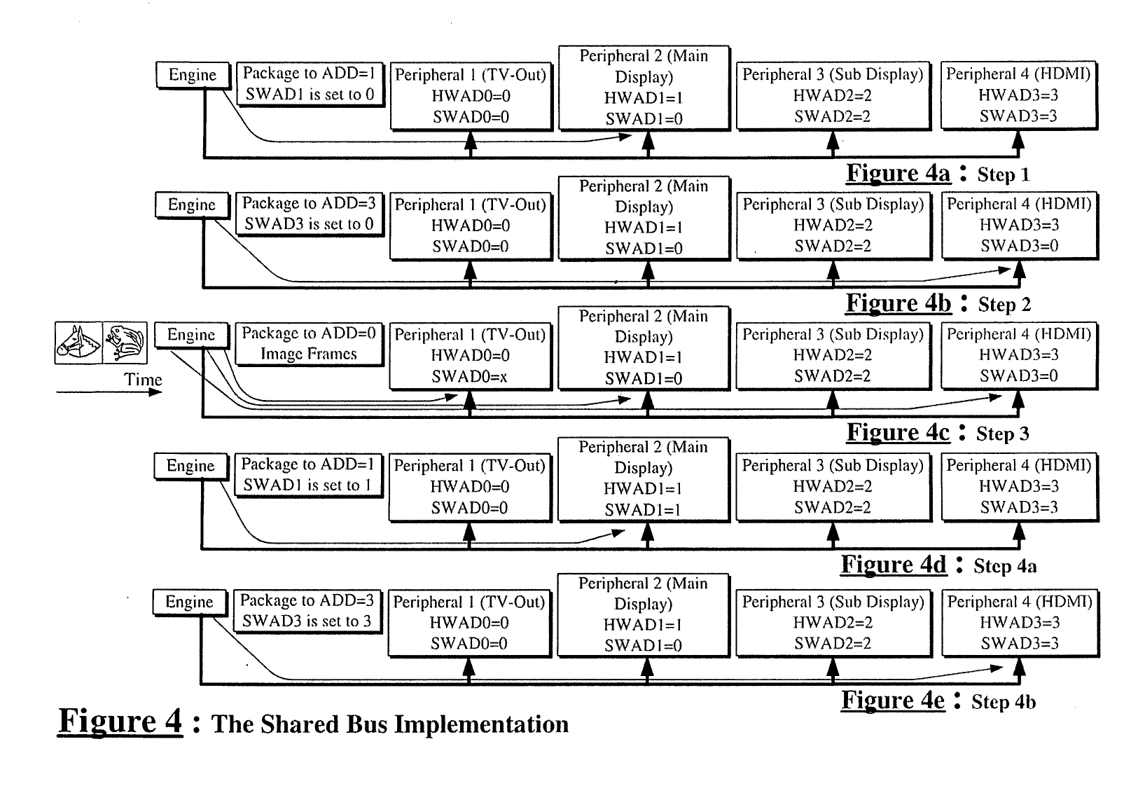

FIG. 4 shows an example of a shared bus case, where the shared bus includes an engine and 4 peripherals, including a 1st peripheral unique address (HWAD0) and configurable address (SWAD0) that are 0, TV-out; a 2nd peripheral unique address (HWAD1) and configurable address (SWAD1) that are 1, Main display; a 3rd peripheral unique address (HWAD2) and configurable address (SWAD2) that are 2, Sub display; and a 4th peripheral unique address (HWAD3) and configurable address (SWAD3) that are 3, HDMI. These configurable addresses (SWAD0, SWAD1, SWAD2 and SWAD3) are in the initial state. In this example, the engine wants to send a video clip to 3 peripherals (e.g. the main display, TV-out and HDMI) at the same time, and the following steps are taken:

In FIG. 4a, the engine sends a command to the 2nd peripheral (Main display), which has the unique address HWAD1=1, that changes the configurable address (SWAD1) of the 2nd peripheral (Main display) to same address what is the 1st peripheral unique address (HWAD0, TV-Out)=>SWAD1=HWAD0=0.

In FIG. 4b, the engine sends a command to the 4th peripheral (HDMI), which has the unique address HWAD3=3, that changes the configurable address (SWAD3) of the 4th peripheral (HDMI) to same address what is the 1st peripheral unique address (HWAD0, TV-Out)=>SWAD3=HWAD0=0.

In FIG. 4c, the engine is starting to send a video clip that is transmitted in one or several frames or packets or messages with an address of 0. The same video clip is received by the 1st peripheral, which unique address is equal to 0 and the 2nd and 4th peripherals, which configurable addresses are 0. The configurable address SWAD0 of the 1^{st} peripheral can have any value.

After Video clip sending, in FIG. 4d the engine may change the configurable address of the 2nd peripheral (SWAD1) to the original address (=>SWAD1=HWAD1) when it is sending a command which is using the unique address of the 2nd peripheral (HWAD1); and in FIG. 4e the engine may change the configurable address of the 4th peripheral (SWAD3) to the original address (=>SWAD3=HWAD3) when it is sending a command which is using the unique address of the 4th peripheral (HWAD3). The scope of the invention is not intended to be limited to the changing of the configurable addresses back to the original address, since the engine or any other entity in the system typically keeps track of the addresses of the peripheral devices.

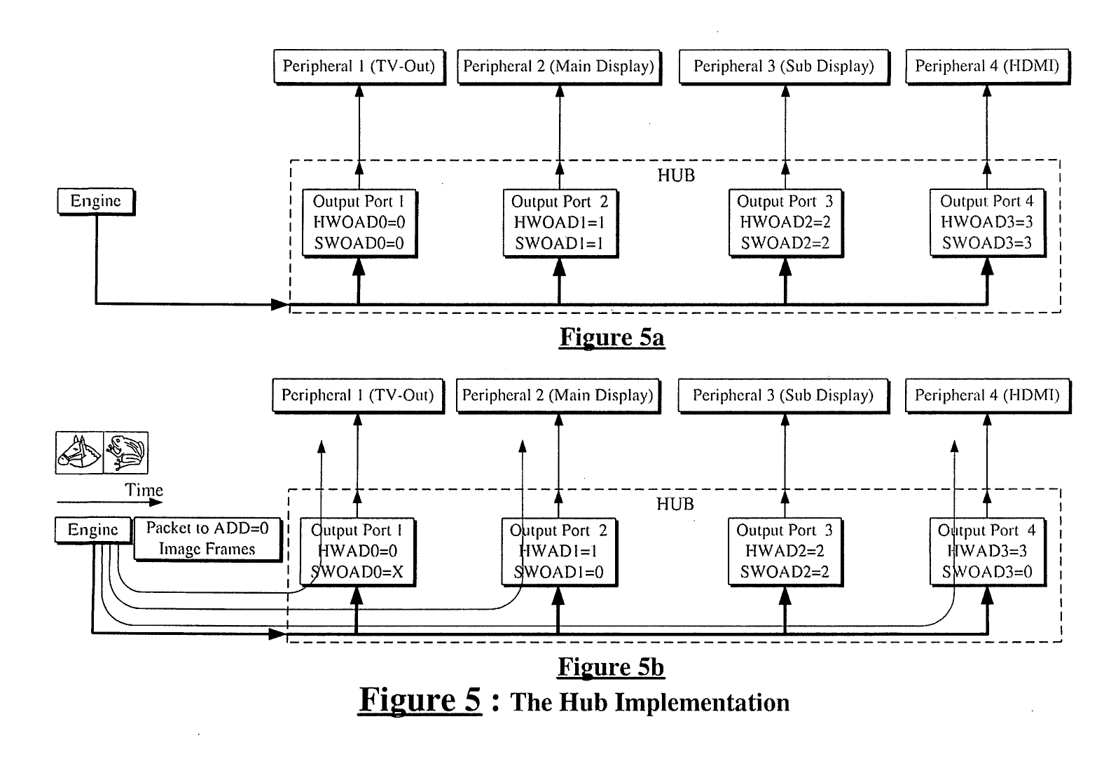

FIG. 5 shows an example of the hub case where the engine is sending commands to the hub in the similar way (HWOADx=HWADX and SWOADx=SWADX) as in the shared bus case, when output ports of the hub has been changed when it is needed.

FIG. 5a shows the unique and configurable addresses before the command and shared data are provided, while FIG. 5b shows the changing of the configurable address of peripherals 2 and 4, and the provisioning of the shared data to peripherals 1, 2 and 4 based on the matching of the unique or configurable addresses.

According to some embodiments, the invention may also take the form of a system that includes a control entity, beside the sender of the shared data and the at least one receiver of the shared data. The control entity in the system is aware of all unique addresses and configurable addresses and is controlling the configurable addresses. The sender of a multicast message may be either listening to the control entity so that it has the latest knowledge about currently used unique and configurable addresses in the system or may be requesting before a normal or multicast message a latest address definition from the control entity.

According to some embodiments, the invention may also take the form of a system that include at least two masters which are both capable of modification of the configurable addresses and also capable of transmitting normal and shared data. In one mode, only one of the masters may be active at the time. In that mode, the master is allowed to modify the configurable addresses according to the needs of the active master. The at least one other master is in a passive mode where it tracks all modifications to the addresses. This tracking allows a smooth master transition from a passive master state to an active master state, and vice versa.

FIG. 6 shows a basic chipset implementation that forms part of the mobile node, point, terminal or device shown in FIG. 1 according to some embodiments of the present invention. Another embodiment of the present invention may also take the form of the chipset for such a node, point, terminal or device in a wireless local area network (WLAN) shown in FIG. 1 or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

By way of example, and consistent with that described herein, the functionality of the modules 20, 22 or 32, 34 may be configured and implemented using hardware, software, firmware, or a combination thereof, although the scope of the invention is not intended to be limited to any particular embodiment thereof. In a typical software implementation, the modules 20, 22 or 32, 34 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 20, 22 or modules 32, 34 being configured as stand alone modules, as shown, or being configured in the combination with other circuitry for implementing another module.

The scope of some embodiments of the invention is intended to include implementing the same in relation to a mobile node, point, terminal or device forming part of a WLAN, such as that shown in FIG. 7.

FIG. 7 shows, by way of example, typical parts of an IEEE 802.11 WLAN system, according to some embodiments of the present invention, and provides for communications between communications equipment such as mobile and secondary devices including personal digital assistants (PDAs), laptops and printers, etc. The WLAN system may be connected to a wired LAN system that allows wireless devices to access information and files on a file server or other suitable device or connecting to the Internet. The scope of the invention is also intended to include implementing the same in relation to such a WLAN.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

Although some embodiment of the present invention is described in relation to a wireless local area network (WLAN), according to some embodiments of the present invention is also applicable to other suitable wireless communications technologies, such as, for example, WiMAX, UWB and/or BT technologies, as well as other suitable network technologies either now known or later developed in the future.

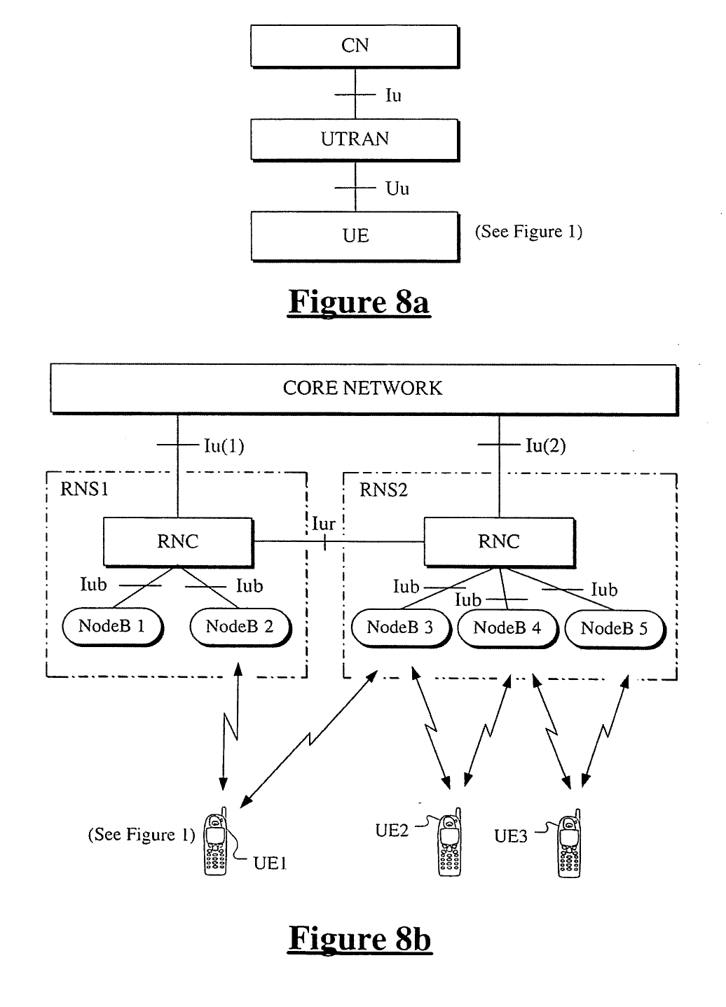

The scope of the invention is also intended to include implementing the same in relation to user equipment that forms part of a Universal Mobile Telecommunications System (UMTS) packet network architecture, such as that shown in FIGS. 8a and 8b, which includes diagrams of the UMTS packet network architecture.

In FIG. 8a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface, and would operate in a manner consistent with that shown and described above, including that shown in FIG. 1.

FIG. 8b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 8a. A given UE may be in radio contact with multiple Node Bs even if one or more of the Node Bs are connected to different RNCs. For instance, a UE1 in FIG. 8b may be in radio contact with Node B2 of RNS1 and Node B3 of RNS2 where Node B2 and Node B3 are neighboring Node Bs. The RNCs of different RNSs may be connected by an lur interface which allows mobile UEs to stay in contact with both RNCs while traversing from a cell belonging to a Node B of one RNC to a cell belonging to a Node B of another RNC. The convergence of the IEEE 802.11 WLAN system in FIG. 7 and the (UMTS) packet network architecture in FIGS. 8a and 8b has resulted in STAs taking the form of UEs, such as mobile phones or mobile terminals. The interworking of the WLAN (IEEE 802.11) shown in FIG. 7 with such other technologies (e.g. 3GPP, 3GPP2 or 802.16) such as that shown in FIGS. 8a and 8b is being defined at present in protocol specifications for 3GPP and 3GPP2. The scope of the invention is also intended to include implementing the same in relation to the interworking of such networks either now known or later developed in the future.

Even if the exemplary embodiment of the present invention is broadly described in the wired data interface environment, it should be understood and appreciated by a person skilled in the art that the exemplary description of the invention can be applied to other serial communication technology systems either now known or later developed in the future.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What is claimed is:

1. A method comprising:
providing a command to update a configurable address of one or more communication nodes in a communication system so as to be able to receive shared data; and
providing the shared data and a destination address so that one or more communication nodes process the shared data if either their respective unique address or configurable address matches the destination address.

2. A method according to claim 1, wherein the one or more communication nodes is a peripheral, including a main display, or a television output, or a sub-display, or a high definition multimedia interface, or a mass storage, or a functional module, in a communication system.

3. A method according to claim 1, wherein the one or more communication nodes are hubs having ports in a hub system.

4. A method according to claim 1, wherein the shared data is a message or a packet or a frame.

5. A method according to claim 1, wherein the method includes configuring different communications nodes to have the same configurable address to receive the shared data.

6. A method according to claim 1, wherein the method includes broadcasting a multicast signal having the shared data and destination address to all nodes in the communication system.

7. Apparatus comprising:
one or more modules configured for providing a command to update a configurable address of one and more communication nodes in a communication system so as to be able to receive shared data; and
one or more modules configured for providing the shared data and a destination address so that one or more communication nodes process the shared data if either their respective unique address or configurable address matches the destination address.

8. Apparatus according to claim 7, wherein the one or more communication nodes is a peripheral, including a main display, or a television output, or a sub-display, or a mass storage, or a high definition multimedia interface, or a functional module, in the communication system.

9. Apparatus according to claim 7, wherein the one or more communication nodes are hubs having output ports in a hub system.

10. Apparatus according to claim 7, wherein the shared data is a message or a packet or a frame.

11. Apparatus according to claim 7, wherein the configurable address is configurable to have the same group address as different communications nodes in the communication system.

12. Apparatus according to claim 7, wherein the shared data and destination address is broadcast to all nodes in the communication system in a multicast message or packet or frame.

13. A system comprising:
one node, point, terminal or device having one or more modules configured for providing a command to update a configurable address of one or more communication nodes in a communication system so as to be able to receive shared data, and for also providing the shared data and a destination address; and
another node, point, terminal or device having one or more modules configured for receiving the command and updating the configurable address so as to be able to receive the shared data, and for also receiving the shared data and the destination address and processing the shared data if either its respective unique address or configurable address matches the destination address.

14. A system according to claim 13, wherein the system is a communication system having the one or more communication nodes as peripherals, including a main display, or a television output, or a sub-display, or a high definition multimedia interface, or a mass storage, or a functional module, or some combination thereof.

15. A system according to claim 13, wherein the system is a hub system having at least one hub with ports.

16. A system according to claim 13, wherein the shared data is a message or a packet or a frame.

17. A system according to claim 13, wherein the system comprises different communications nodes that are configurable to have the same configurable address to receive the shared data.

18. A system according to claim 13, wherein the shared data and destination address is broadcast to all nodes in the communication system in a multicast signal.

19. A method according to claim 1, wherein the method is implemented in a chipset comprising:
one or more modules configured for providing a command to update a configurable address of one or more communication nodes in a communication system so as to be able to receive shared data; and
one or more modules configured for providing the shared data and a destination address so that one or more communication nodes process the shared data if either their respective unique address or configurable address matches the destination address.

20. A method according to claim 1, wherein the method is implemented in a computer program product with a program code, which program code is stored on a machine readable medium, for carrying out the steps of the method via a computer program running in a processor, controller or other suitable module in one or more nodes, points, terminals, devices or functional modules in the communication system.

21. A method according to claim 1, wherein the method further comprises implementing the step of the method via a computer program running in a processor, controller or other suitable module in a node, point, terminal, device or functional module.

22. Apparatus comprising:
means for providing a command to update a configurable address of one or more communication nodes in a communication system so as to be able to receive shared data; and
means for providing the shared data and a destination address so that one or more communication nodes process the shared data if either their respective unique address or configurable address matches the destination address.

23. A method comprising:
receiving in a communication node in a communication system a command to update a configurable address so as to be able to receive shared data; and
receiving in the communication node the shared data and a destination address so that the communication node processes the shared data if either its respective unique address or configurable address matches the destination address.

24. A method according to claim 23, wherein the communication node is a peripheral, including a main display, or a television output, or a sub-display, or a high definition multimedia interface, or a mass storage device, or a functional module, in the communication system.

25. A method according to claim 23, wherein the communication node is a hub having at least one port in a hub system.

26. A method according to claim 23, wherein the shared data is a message or a packet or a frame.

27. A method according to claim 23, wherein the method includes configuring different communications nodes to have the same configurable address to receive the shared data.

28. A method according to claim 23, wherein the method includes broadcasting a multicast signal having the shared data and destination address to all nodes in the communication system.

29. Apparatus comprising:
one or more modules configured for receiving in a communication node in a communication system a command to update a configurable address so as to be able to receive shared data; and
one or more modules configured for receiving in the communication node the shared data and a destination address so that the communication node processes the shared data if either its respective unique address or configurable address matches the destination address.

30. Apparatus according to claim 29, wherein the communication node is a peripheral, including a main display, or a television output, or a sub-display, or a high definition multimedia interface, or a mass storage, or a functional module, in the communication system.

31. Apparatus according to claim 29, wherein the communication node is a hub having at least one output port in a hub system.

32. Apparatus according to claim 29, wherein the shared data is a message or a packet or a frame.

33. Apparatus according to claim 29, wherein the shared data and destination address are broadcast to all nodes in the communication system in a multicast signal.

34. A method according to claim 23, wherein the method is implemented in a chipset comprising:
one or more modules configured for receiving a command to update a configurable address of one or more communication node in a communication system so as to be able to receive shared data; and
one or more modules configured for receiving the shared data and a destination address so that one or more communication nodes process the shared data if either their respective unique address or configurable address matches the destination address.

35. A method according to claim 23, wherein the method is implemented in a computer program product with a program code, which program code is stored on a machine readable medium, for carrying out the steps of the method via a computer program running in a processor, controller or other suitable module in one or more nodes, points, terminals or devices in the communication system.

36. A method comprising:
updating a configurable address of a communication node in a communication system so as to be able to receive shared data; and
processing the shared data in the communication node if either its respective unique address or configurable address matches a destination address associated with the shared data.

37. Apparatus comprising:
means for receiving in a communication node in a communication system a command to update a configurable address so as to be able to receive shared data; and
means for receiving in the communication node the shared data and a destination address so that the communication node processes the shared data if either its respective unique address or configurable address matches the destination address.

38. A system according to claim 13, wherein the system comprises a control entity that is aware of all unique and configurable addresses and controls the configurable addresses.

39. A system according to claim 13, wherein the one node, point, terminal, or device that provides a multicast message is either listening to the control entity so that it has the latest knowledge about currently used unique and configurable addresses in the system or is requesting before a normal or multicast message a latest address definition from the control entity.

40. A system according to claim 13, wherein the system comprises at least two masters which are both capable of modification of the configurable addresses and capable of transmitting normal and shared data.

41. A system according to claim 40, wherein in one mode only one of the masters is active at a time.

42. A system according to claim 41, wherein in the one mode an active master is allowed to modify the configurable addresses according to its needs.

43. A system according to claim 42, wherein the at least one other master is in a passive mode where it tracks all modifications to the addresses, so as to allow a smooth master transition from a passive master state to an active master state, and vice versa.
